(19) United States
(12) Patent Application Publication
(10) Pub. No.: US 2026/0345428 A1
(43) Pub. Date: Nov. 5, 2026

(54) MASSAGE DEVICE

(71) Applicant: Kaihao CHEN, Wenzhou (CN)

(72) Inventor: Kaihao CHEN, Wenzhou (CN)

(21) Appl. No.: 19/712,467

(22) Filed: Jun. 18, 2026

(51) Int. Cl. A61H 15/00

(52) U.S. Cl. CPC A61H 15/0085; A61H 2015/0021; A61H 2201/0153; A61H 2201/1238

(57) ABSTRACT

A massage device, including: a gripping assembly having a housing, a massage assembly having a mounting frame and at least one massage component and a driving assembly. The housing includes a first end and a second end disposed opposite each other. The mounting frame is rotatably connected to the first end and the second end of the housing so as to be rotatable about a first axis, and the at least one massage component is rotatably mounted to the mounting frame so as to be rotatable about a second axis different from the first axis. The driving assembly is configured to rotate the mounting frame about the first axis.

### TECHNICAL FIELD

The present disclosure relates to the technical field of health care devices, in particular to a massage device.

### BACKGROUND

Massage devices, serving as commonly used equipment for people to relax muscles in daily life, are widely applied in gyms, homes, offices, and physiotherapy venues. Traditional massage devices are often large in volume, inconvenient to carry, and complicated to operate, making it difficult to satisfy users' demands for muscle relaxation anytime and anywhere. Handheld massage devices have therefore emerged in response to this need.

At present, most massage components of existing massage devices available on the market adopt fixed rotation or simple vibration working modes. The massage forms are relatively singular, capable only of providing users with simple tapping or circular motions. It is difficult for them to realize complex massage actions, resulting in insufficiently rich massage experiences and relaxation effects that remain to be improved.

To this end, the present disclosure provides a massage device that can effectively solve the above-mentioned problems. The massage device has a simple structure, diverse massage forms, and comfortable user experience.

### SUMMARY

In order to overcome the deficiencies of the prior arts, the present disclosure provides a massage device that has a simple structure, diverse massage forms, and comfortable experience.

To realize the above objective, the present disclosure provides a massage device, including: a gripping assembly having a housing, the housing comprises a first end and a second end disposed opposite each other; a massage assembly having a mounting frame and at least one massage component, wherein the mounting frame is rotatably connected to the first end and the second end of the housing so as to be rotatable about a first axis, and the at least one massage component being rotatably mounted to the mounting frame so as to be rotatable about a second axis different from the first axis; and a driving assembly configured to rotate the mounting frame about the first axis.

The beneficial effects of the present disclosure are as follows: when the driving assembly drives the mounting frame to rotate about its first axis a, the mounting frame drives at least one massage component to revolve together around the first axis a. At the same time, since each massage component is also rotatably connected to the mounting frame, an individual massage component is also capable of rotating (self-rotating) relative to the mounting frame about the second axis b of the massage component during the revolving process. This dual massage mode of “revolution+rotation” enables the at at least one massage component, when in operation, on the one hand, to allow the at least one massage component to perform large-range rotational massage around the first axis a on the user's neck, waist, or limbs; and on the other hand, to enable an individual massage component, through the frictional force generated when it contacts the surface of the user, to rotate about the second axis b, thereby realizing complex massage effects.

### BRIEF DESCRIPTION OF DRAWINGS

In order to more clearly illustrate the technical solutions in the embodiments of the present disclosure, a brief introduction will be given below to the accompanying drawings required for use in the description of the embodiments. The drawings in the following description are merely some embodiments of the present disclosure. For those of ordinary skill in the art, other drawings may also be obtained based on these drawings without involving any creative effort.

The present disclosure will be further described below in conjunction with the accompanying drawings and embodiments.

FIG. 1 is a schematic structural diagram of a massage device according to a first embodiment of the present disclosure from one perspective;

FIG. 2 is a schematic structural diagram of the massage device according to the first embodiment of the present disclosure from another perspective;

FIG. 3 is an exploded view of the massage device according to the first embodiment of the present disclosure;

FIG. 4 is a first cross-sectional view of the massage device according to the first embodiment of the present disclosure;

FIG. 5 is a second cross-sectional view of the massage device according to the first embodiment of the present disclosure;

FIG. 6 is a schematic structural diagram of a massage assembly of the massage device according to the first embodiment of the present disclosure;

FIG. 7 is an exploded view of the massage assembly 200 of the massage device according to the first embodiment of the present disclosure;

FIG. 8 is a schematic structural diagram of a mounting frame of the massage device according to the first embodiment of the present disclosure;

FIG. 9 is a schematic structural diagram of the massage device according to the first embodiment of the present disclosure in a stored state;

FIG. 10 is an exploded view of the massage device according to the first embodiment of the present disclosure in the stored state;

FIG. 11 is a schematic structural diagram of a massage device according to a second embodiment of the present disclosure from one perspective;

FIG. 12 is a schematic structural diagram of the massage device according to the second embodiment of the present disclosure from another perspective;

FIG. 13 is an exploded view of the massage device according to the second embodiment of the present disclosure;

FIG. 14 is a cross-sectional view of the massage device according to the second embodiment of the present disclosure;

FIG. 15 is a schematic structural diagram of the massage device according to the second embodiment of the present disclosure in a stored state;

FIG. 16 is an exploded view of the massage device according to the second embodiment of the present disclosure in the stored state;

FIG. 17 is a schematic structural diagram of a massage device according to a third embodiment of the present disclosure from one perspective;

FIG. 18 is a schematic structural diagram of the massage device according to the third embodiment of the present disclosure from another perspective;

FIG. 19 is an exploded view of the massage device according to the third embodiment of the present disclosure;

FIG. 20 is a cross-sectional view of the massage device according to the third embodiment of the present disclosure;

FIG. 21 is an enlarged view of a portion A circled in FIG. 20;

FIG. 22 is a schematic structural diagram of the massage device according to the third embodiment of the present disclosure in a stored state;

FIG. 23 is an exploded view of the massage device according to the third embodiment of the present disclosure in the stored state;

FIG. 24 is a schematic structural diagram of the massage device according to the third embodiment of the present disclosure in a use state;

FIG. 25 is a cross-sectional view of the massage device according to the third embodiment of the present disclosure in another use state

### DESCRIPTION OF THE REFERENCE NUMERALS

100, gripping assembly; 110, housing; 111, accommodating space; 112, gripping portion; 113, upper housing; 114, lower housing; 120, first end; 121, first mounting groove; 122, threaded mounting member; 123, sealing member; 130, second end; 131, second mounting groove; 140, opening; 200, massage assembly; 210, mounting frame; 211, first mounting bracket; 2111, first mounting portion; 212, second mounting bracket; 2121, second mounting portion; 213, mounting shaft; 220, massage component; 221, first insertion portion; 222, second insertion portion; 300, driving assembly; 310, battery; 311, charging port; 320, driving member; 321, worm screw; 322, gear; 330, control button; 341, first bearing; 342, second bearing; 400, handle; 410, threaded connecting member; 500, base.

### DETAILED DESCRIPTION OF THE EMBODIMENTS

To make the above-mentioned objects, features, and advantages of the present disclosure more apparent and comprehensible, the specific embodiments of the present disclosure will be described in detail below with reference to the accompanying drawings. In the following description, numerous specific details are set forth in order to provide a thorough understanding of the present disclosure. However, the present disclosure can be implemented in many other ways different from those described herein, and those skilled in the art can make similar improvements without departing from the spirit of the present disclosure. Therefore, the present disclosure is not limited by the specific embodiments disclosed below.

In the description of the present disclosure, it should be understood that when the terms “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like appear, the azimuth or positional relationships indicated by these terms are based on the azimuth or positional relationships shown in the accompanying drawings, which are merely for the convenience of describing the present disclosure and simplifying the description, rather than indicating or implying that the referred device or element must have a specific orientation, be constructed and operated in a specific orientation. Therefore, these terms should not be construed as limiting the present disclosure.

In addition, when the terms “first” and “second” appear, these terms are used for descriptive purposes only and should not be construed as indicating or implying relative importance or implicitly indicating the number of the indicated technical features. Thus, a feature defined as “first” or “second” may explicitly or implicitly include at least one of the features. In the description of the present disclosure, when the term “plurality” appears, the meaning of “plurality” is at least two, for example, two, three, etc., unless otherwise explicitly and specifically limited.

In the present disclosure, unless otherwise expressly specified and limited, when the terms “install,” “connect,” “link,” “fix,” and the like appear, these terms should be understood in a broad sense. For example, it may be a fixed connection, a detachable connection, or an integral connection; it may be a mechanical connection or an electrical connection; it may be a direct connection or an indirect connection through an intermediate medium, or it may be an internal communication between two elements or an interaction relationship between two elements, unless otherwise expressly limited. For those of ordinary skill in the art, the specific meanings of the above terms in the present disclosure can be understood according to specific circumstances.

In the present disclosure, unless otherwise expressly specified and limited, when descriptions such as a first feature being “on” or “under” a second feature or similar descriptions appear, it may mean that the first and second features are in direct contact, or that the first and second features are in indirect contact through an intermediate medium. Moreover, the first feature being “above,” “over,” or “on” the second feature may mean that the first feature is directly above or obliquely above the second feature, or merely indicates that the first feature is horizontally higher than the second feature. The first feature being “below,” “under,” or “beneath” the second feature may mean that the first feature is directly below or obliquely below the second feature, or merely indicates that the first feature is horizontally lower than the second feature.

It should be noted that if an element is referred to as being “fixed to” or “disposed on” another element, it may be directly on the other element or there may be an intervening element. If an element is considered to be “connected to” another element, it may be directly connected to the other element or there may be an intervening element present. If present, the terms “vertical,” “horizontal,” “upper,” “lower,” “left,” “right,” and similar expressions used in the present disclosure are for illustrative purposes only and do not indicate that they are the only embodiments.

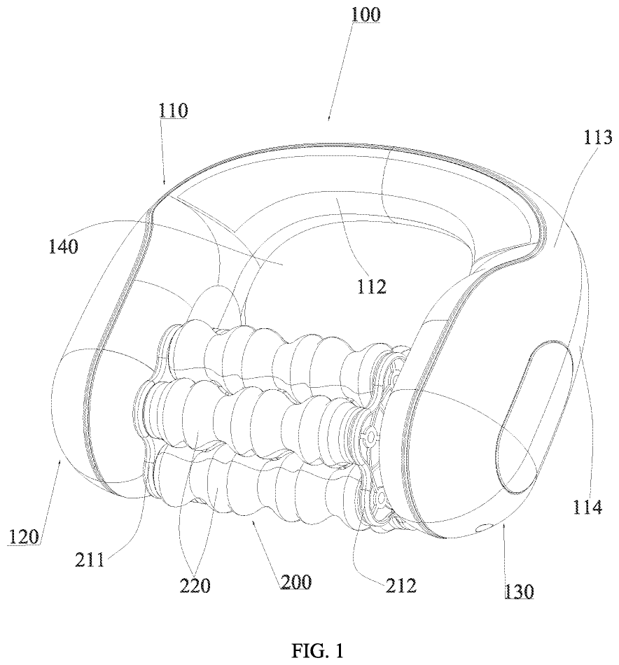

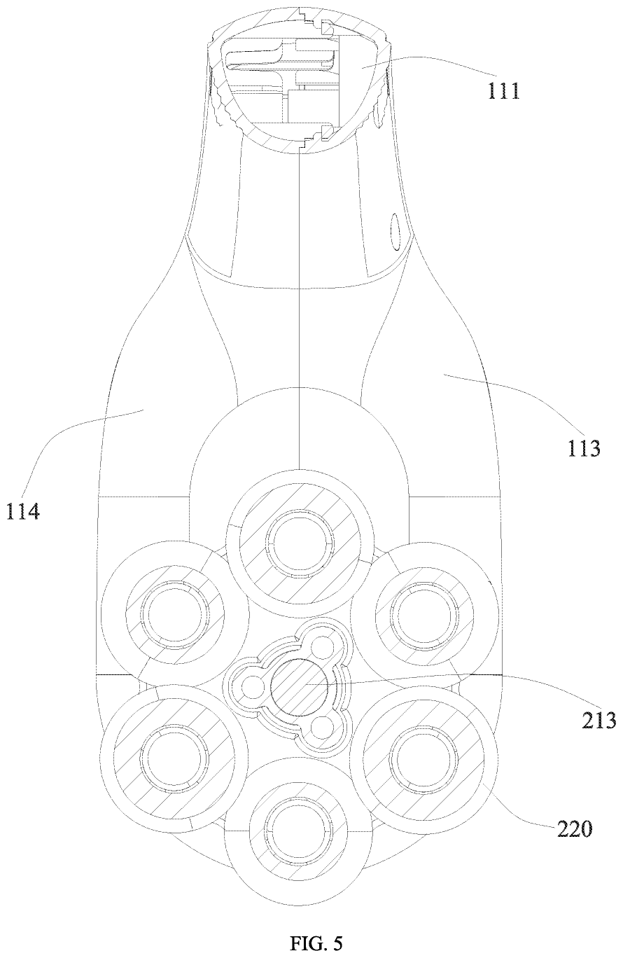

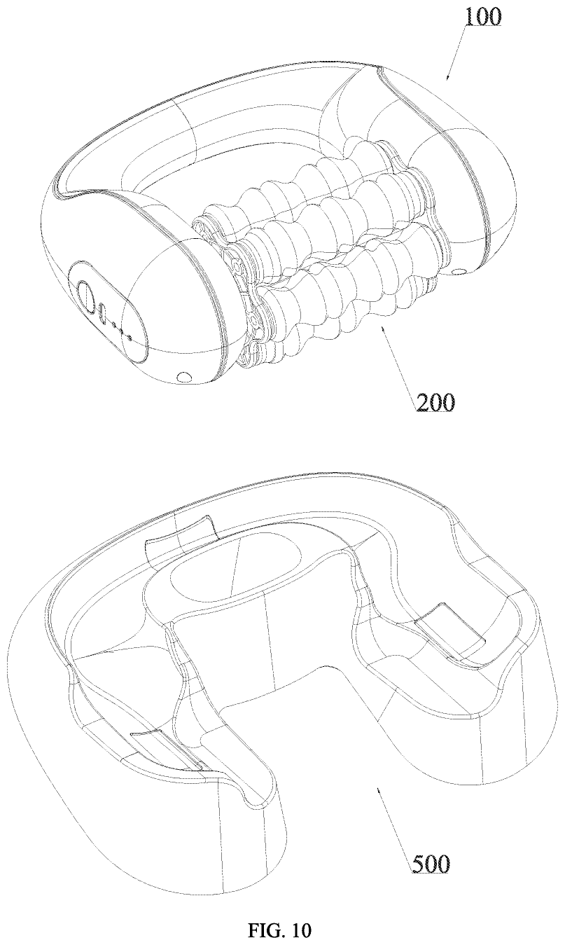

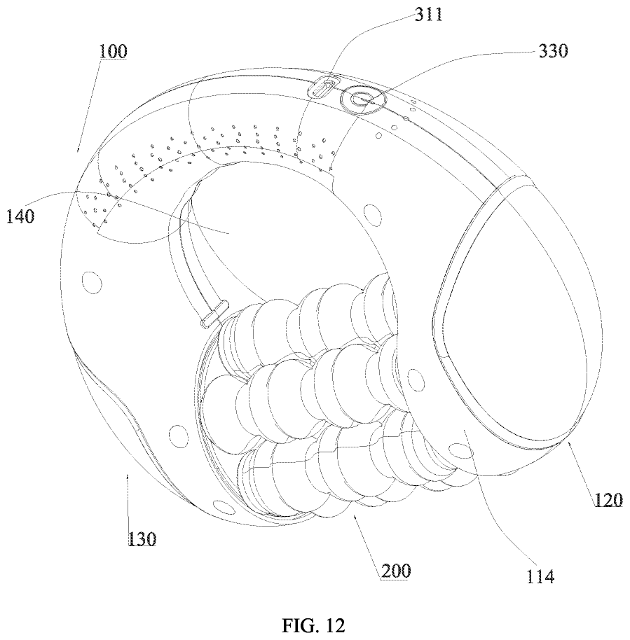

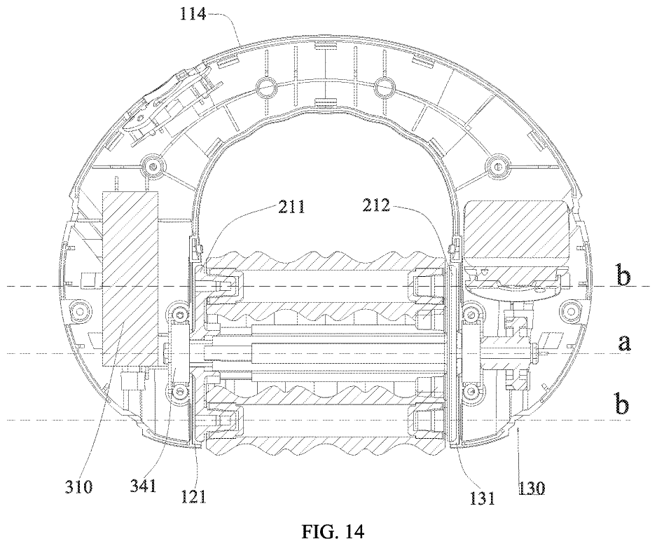

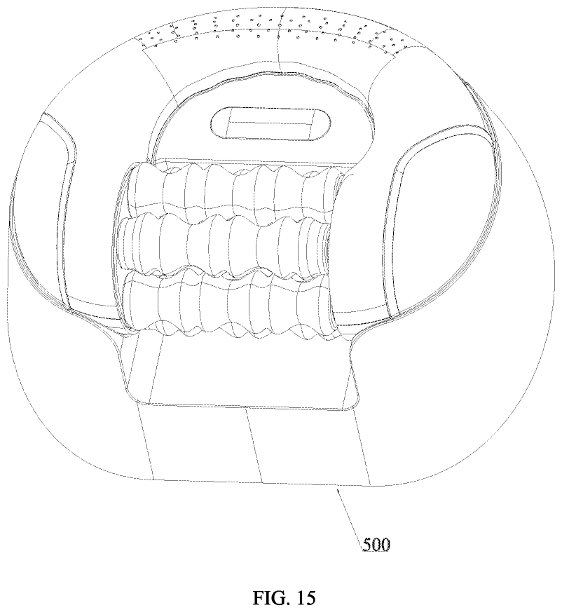

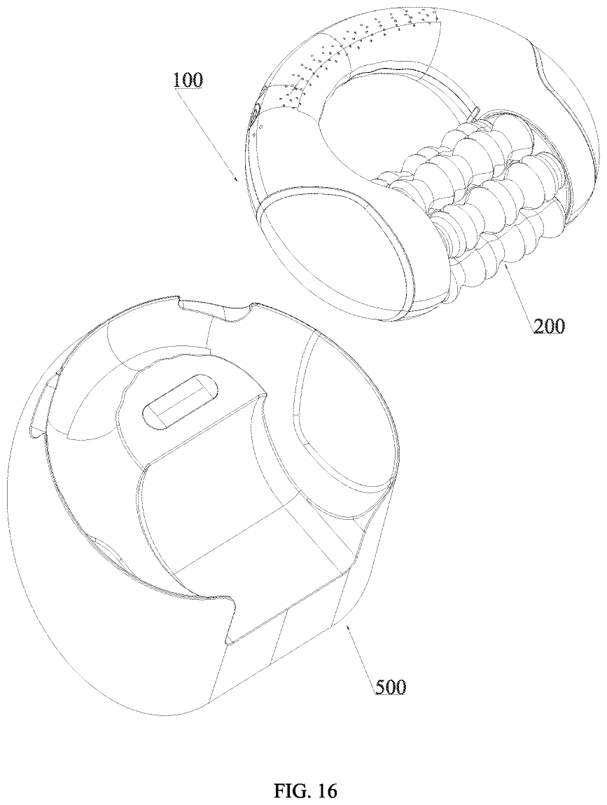

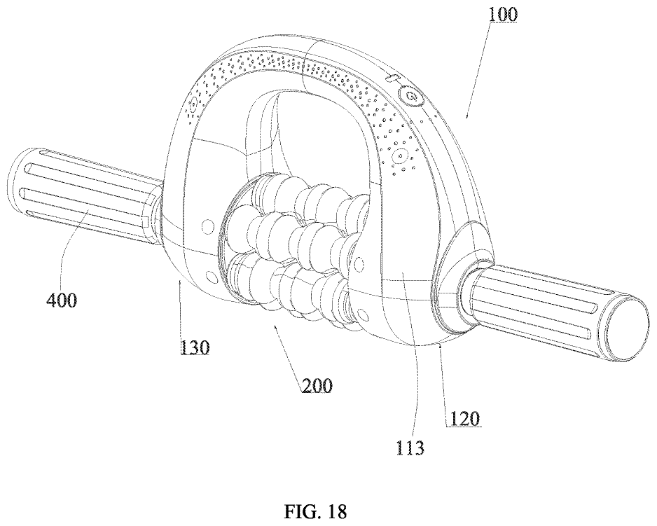

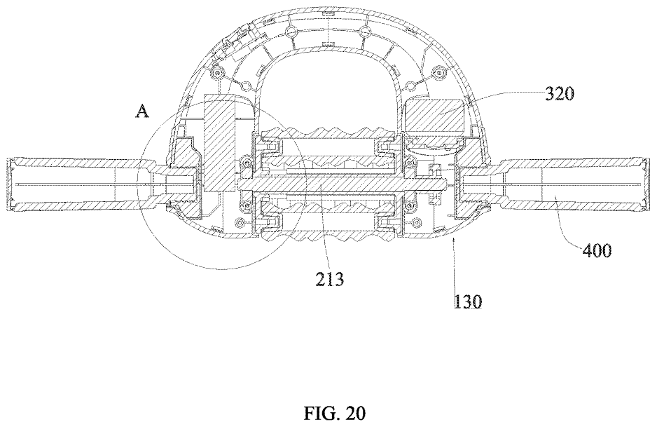

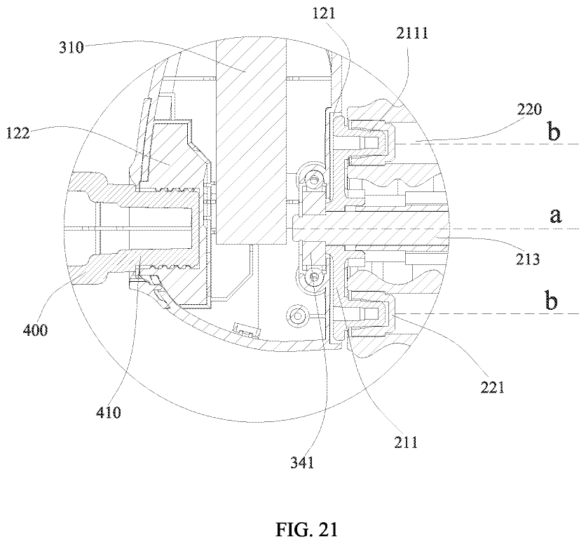

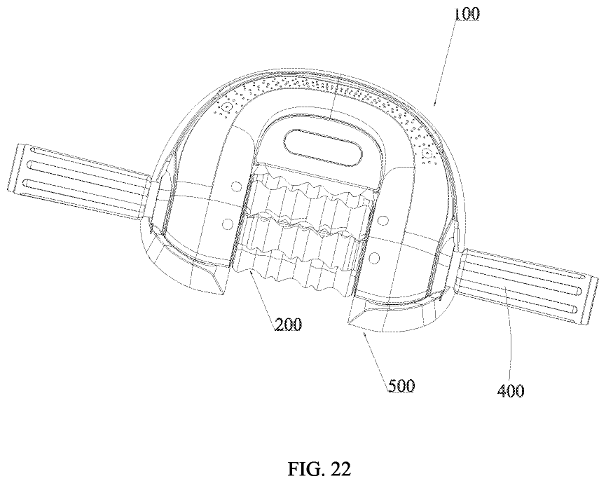

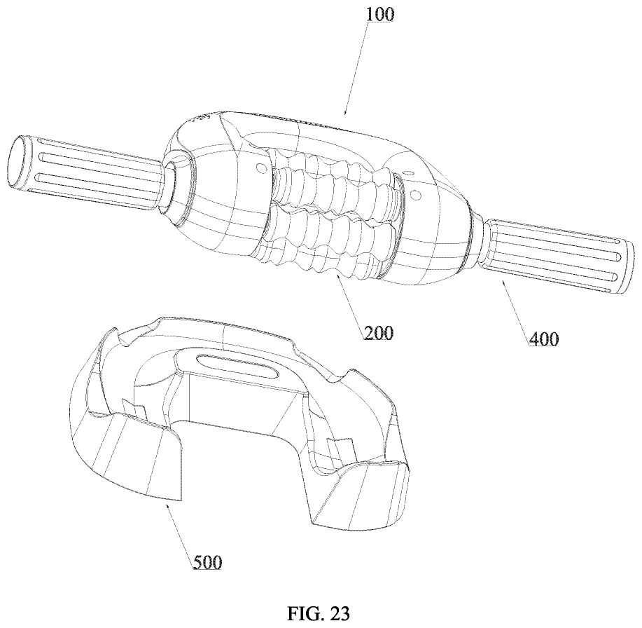

Referring to FIGS. 1 to 25, a massage device includes:
a gripping assembly 100 having a housing 110, the housing 110 includes a first end 120 and a second end 130 disposed opposite each other;
a massage assembly 200 having the mounting frame 210 and at least one massage component 220, one side of the mounting frame 210 is rotatably connected to the first end 120, and another side is rotatably connected to the second end 130, and the at least one massage component 220 is rotatably connected to the mounting frame 210;
a driving assembly 300 configured to drive the mounting frame 210 to rotate about the first axis a of the mounting frame 210, and the at least one massage component 220 is capable of rotating about a second axis b of the massage component 220.

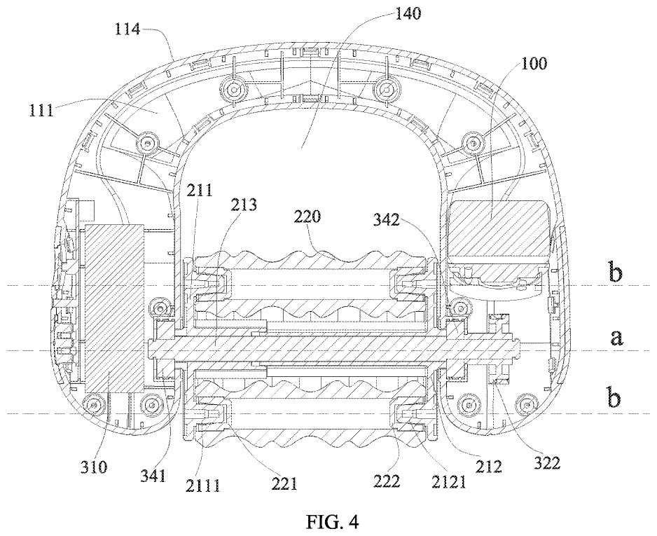

Through the arrangement of the above structure, as shown in FIGS. 4, 7, 14, and 21, when the driving assembly 300 drives the mounting frame 210 to rotate about its own first axis a, the mounting frame 210 drives the at least one massage component 220 to revolve about the first axis a. At the same time, since each massage component 220 is also rotatably connected to the mounting frame 210, a single massage component 220 can also rotate (spin) relative to the mounting frame 210 about the second axis b of the massage component 220 during the revolving process. This dual massage mode of “revolution+rotation” enables the at least one massage component 220, on the one hand, to perform large-range rotational massage around the first axis a on the user's neck, waist, or limbs when in operation. On the other hand, the friction force generated when a single massage component 220 contacts the user's surface prompts the single massage component 220 to rotate about its own second axis b, thereby achieving complex massage effects.

In this embodiment, the mounting frame 210 includes a first mounting bracket 211, a second mounting bracket 212, and the mounting shaft 213. The mounting shaft 213 defines the first axis a. Both ends of the mounting shaft 213 are rotatably connected to the first end 120 and the second end 130. The first mounting bracket 211 and the second mounting bracket 212 are fixedly connected to the mounting shaft 213, and the first mounting bracket 211 is located on the side of the mounting shaft 213 close to the first end 120, while the second mounting bracket 212 is located on the side of the mounting shaft 213 close to the second end 130. The driving assembly 300 is connected to the mounting shaft 213 and drives the mounting shaft 213 to rotate about the first axis a, so as to drive the first mounting bracket 211 and the second mounting bracket 212 to rotate synchronously.

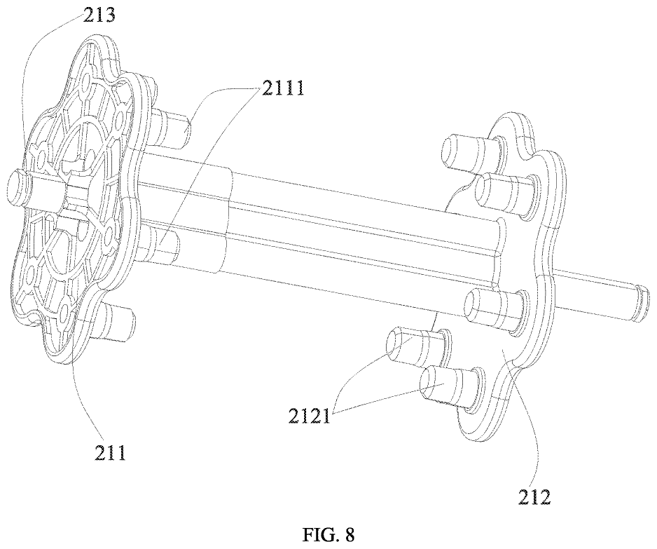

Through the arrangement of the above structure, as shown in FIG. 8, the mounting frame 210 adopts a split structure and is jointly constituted by the first mounting bracket 211, the second mounting bracket 212, and the mounting shaft 213. The mounting shaft 213 not only serves as a rotational connecting member between the first mounting bracket 211, the second mounting bracket 212, and the gripping assembly 100, but the first axis a defined by the mounting shaft 213 also serves as the revolution axis of the massage assembly 200. Since both ends of the mounting shaft 213 are rotatably connected to the first end 120 and the second end 130 of the housing 110 respectively, a stable double-end support structure is formed, which ensures the stability of the mounting frame 210 rotating about the first axis a. Preferably, the first mounting bracket 211 and the second mounting bracket 212 are respectively arranged on the two sides of the mounting shaft 213 close to the first end 120 and the second end 130, so that the massage components 220 can be distributed in the direction around the first axis a, thereby expanding the coverage range of the massage assembly 200 during operation. The driving assembly 300 is connected to the mounting shaft 213. When the driving assembly 300 drives the mounting shaft 213 to rotate about the first axis a, the first mounting bracket 211 and the second mounting bracket 212 fixedly connected to the mounting shaft 213 will rotate synchronously about the first axis a. At this time, the at least one massage component 220 located on the mounting frame 210 also revolve about the first axis a.

In this embodiment, the first mounting bracket 211 is provided with a first mounting portion 2111, and the second mounting bracket 212 is provided with a second mounting portion 2121 opposite to the first mounting portion 2111. The two ends of the massage component 220 are rotatably connected to the first mounting portion 2111 and the second mounting portion 2121 respectively. Through the arrangement of the above structure, the two ends of the massage component 220 are rotatably connected to the first mounting portion 2111 and the second mounting portion 2121 respectively, forming a double-end rotational connection. During the revolution of the at least one massage component 220 and the rotation of each massage component 220, the two ends of the massage component 220 are subjected to uniform force. The first mounting portion 2111 and the second mounting portion 2121 are oppositely arranged on the first mounting bracket 211 and the second mounting bracket 212 respectively, which facilitates the consistency of rotation of the at least one massage component 220 when revolving about the first axis a.

In this embodiment, both ends of the massage component 220 are provided with a first insertion portion 221 and a second insertion portion 222. The first insertion portion 221 and the second insertion portion 222 together define the second axis b. The first insertion portion 221 is movably inserted into the first mounting portion 2111, and the second insertion portion 222 is movably inserted into the second mounting portion 2121. Moreover, the massage component 220 is rotatable about the second axis b.

Through the arrangement of the aforementioned structure, as shown in FIGS. 4, 14, and 21, the massage component 220 is movably inserted into the first mounting portion 2111 and the second mounting portion 2121 respectively via the first insertion portion 221 and the second insertion portion 222 at its two ends. Furthermore, the first insertion portion 221 and the second insertion portion 222 jointly define a self-rotation second axis b, such that each massage component 220 rotates about the second axis b. It should be noted that the number of axes b corresponds to the number of the at least one massage component 220, and the first axis a is arranged parallel to the second axis b. This parallel arrangement of the axes enables the massage component 220 to maintain a stable rotating massage state in contact with the user throughout the revolution process; simultaneously, each massage component 220 rotates independently, thereby enriching the massage modalities.

In this embodiment, the massage component 220 is of a hollow structure, and the first insertion portion 221 and the second insertion portion 222 are interference-fitted within the massage component 220. Through the arrangement of the aforementioned structure, the massage component 220 adopts a hollow structure, which effectively reduces the weight of each individual massage component 220. In addition, the interference fit creates a firm, static fixed connection between the first insertion portion 221 and the second insertion portion 222 and the inner wall of the massage component 220, ensuring that each massage component 220 can rotate together with the first insertion portion 221 and the second insertion portion 222 about the second axis b.

In this embodiment, the first mounting portion 2111 extends from the first mounting bracket 211 toward the second mounting bracket 212, and the second mounting portion 2121 extends from the second mounting bracket 212 toward the first mounting bracket 211. At least a portion of the first mounting portion 2111 and/or at least a portion of the second mounting portion 2121 extends into an interior of the massage component 220.

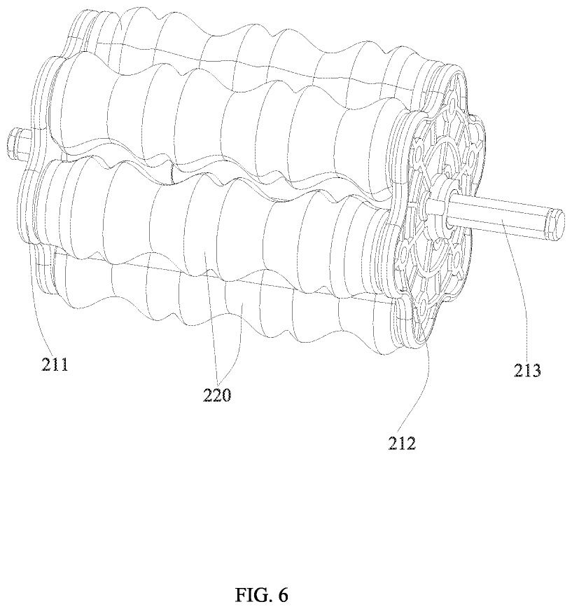

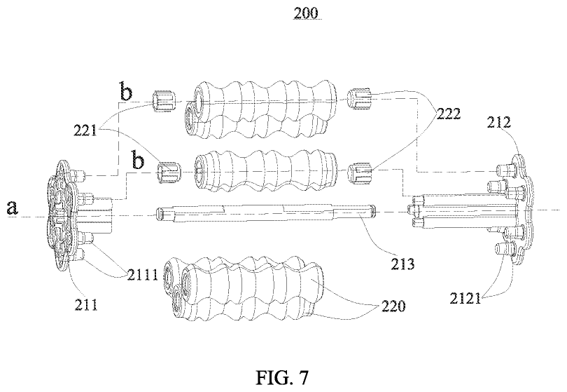

Through the arrangement of the aforementioned structure, as shown in FIGS. 7 and 8, the first mounting portion 2111 and the second mounting portion 2121 extend in opposite directions from the first mounting bracket 211 and the second mounting bracket 212 respectively, such that at least part of the extending segments protrude into the internal cavity of the massage component 220—that is, the first mounting portion 2111 is inserted into the first insertion portion 221, the second mounting portion 2121 is inserted into the second insertion portion 222, and the inserted portions are located within the hollow portion of the massage component 220. This mutually inserted structure extends the supporting and mating length between the massage component 220 and the mounting frame 210, making the rotation of the massage component 220 more stable. In addition, as shown in FIG. 6, the three-layer nested structure of “mounting portion (first mounting portion 2111 and second mounting portion 2121)—insertion portion (first insertion portion 221 and second insertion portion 222)—massage component 220” makes the overall massage component assembly 200 more compact.

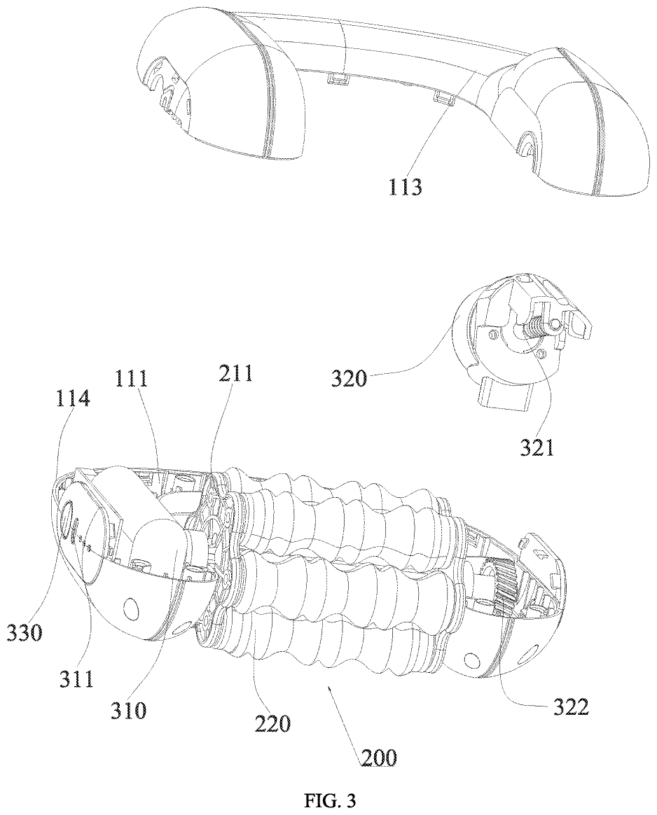

In this embodiment, the housing 110 includes an upper housing 113 and a lower housing 114 which together define an accommodating space 111. Through the arrangement of the aforementioned structure, as shown in FIGS. 3, 13, and 19, the housing 110 is composed of the upper housing 113 and the lower housing 114, which together define the accommodating space 111. The accommodating space 111 provides sufficient room for components such as the drive assembly 300, maintains reasonable clearances between the various components, and is also conducive to heat dissipation.

In this embodiment, the drive assembly 300 includes a battery 310 and a driving member 320. The battery 310 and the driving member 320 are located within the accommodating space 111, and the battery 310 supplies power to the driving member 320. Through the arrangement of the aforementioned structure, as shown in FIGS. 3-4, 13-14, and 19-20, both the battery 310 and the driving member 320 are located within the accommodating space 111 defined by the housing 110. The battery 310 supplies power to the driving member 320, which directly drives the massage assembly 200 to perform massage operations. This integrated layout allows the entire massage device to operate without an external power source, enabling it to function as a standalone portable device whose usage scenarios are not restricted by location. It should be noted that an external power source may also be used to power the massage device.

In this embodiment, the driving member 320 is provided with a worm screw 321 and a gear 322 that meshes with the worm screw 321. The gear 322 is sleeved on the outer periphery of the mounting shaft 213. The driving member 320 drives the worm screw 321 to rotate, which in turn drives the gear 322 to rotate synchronously, thereby causing the mounting shaft 213 to rotate about the first axis a. Through the arrangement of the aforementioned structure, as shown in FIGS. 3, 13, and 19, the driving member 320 is provided with the worm screw 321, and the gear 322 is sleeved on the outer periphery of the mounting shaft 213 and meshes with the worm screw 321. When the driving member 320 operates, the worm screw 321 drives the gear 322 to rotate, which in turn drives the mounting shaft 213 to rotate about its first axis a. At this time, the mounting shaft drives the entire mounting frame 210 to rotate about the first axis a.

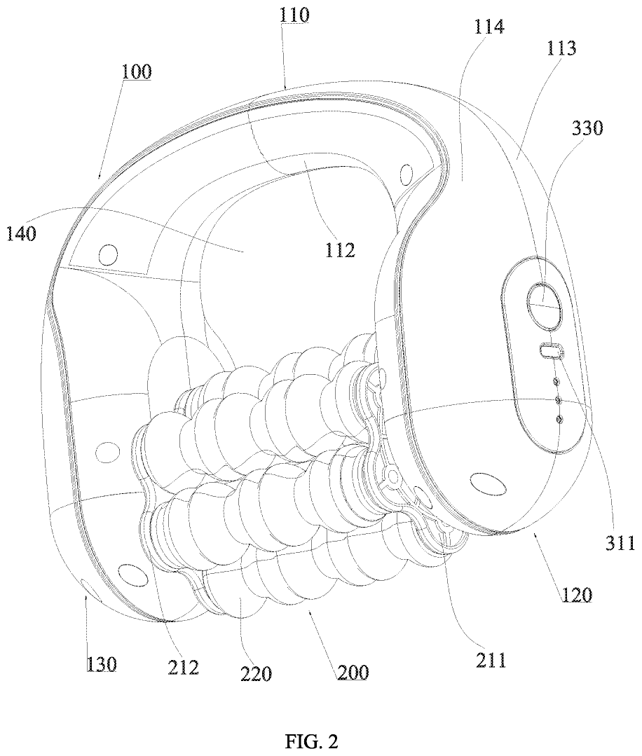

In this embodiment, the drive assembly 300 further includes a control button 330. The control button 330 is configured to control at least one of power on/off and rotation frequency of the driving member 320 when the battery 310 supplies power. Through the arrangement of the aforementioned structure, as shown in FIGS. 2, 12, and 18, the drive assembly 300 is further provided with a control button 330. When the battery 310 supplies power, the control button 330 is used to control the start and stop (on/off) of the driving member 320 and to adjust the rotation frequency of the driving member 320 (i.e., rotation frequency or revolution speed). Optionally, the number of control buttons 330 is one, and the user can complete all control operations through different pressing methods (for example, a short press for power on/off, and a long press or continuous press for cyclic adjustment of the rotation frequency).

In this embodiment, the drive assembly 300 further includes a first bearing 341 and a second bearing 342. The first bearing 341 is located at the first end 120, and the second bearing 342 is located at the second end 130. The two ends of the mounting shaft 213 are respectively mounted and connected to the first bearing 341 and the second bearing 342. Through the arrangement of the aforementioned structure, as shown in FIGS. 4, 14, and 21, the drive assembly 300 further includes the first bearing 341 and the second bearing 342, wherein the first bearing 341 is disposed at the first end 120 and the second bearing 342 is disposed at the second end 130. The two ends of the mounting shaft 213 are rotatably connected to the first bearing 341 and the second bearing 342 respectively. The first bearing 341 and the second bearing 342 constitute the bearing structure for the mounting shaft 213, enabling the mounting shaft 213 to rotate smoothly about the first axis a under the drive of the driving member 320.

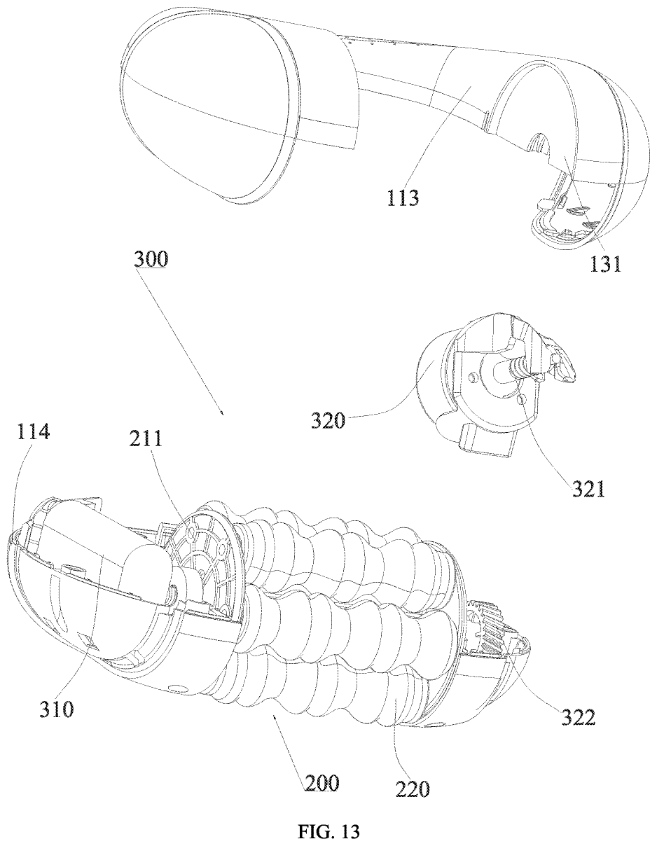

In this embodiment, the first end 120 is provided with a first mounting groove 121, and the second end 130 is provided with a second mounting groove 131. The first mounting groove 121 allows the first mounting bracket 211 to be inserted therein, such that the outer side surface of the first mounting bracket 211 is flush with the outer surface of the first end 120. The second mounting groove 131 allows the second mounting bracket 212 to be inserted therein, such that the outer side surface of the second mounting bracket 212 is flush with the outer surface of the second end 130. Through the arrangement of the aforementioned structure, as shown in FIGS. 13-14, 19, and 21, the first end 120 of the housing 110 is provided with the first mounting groove 121, and the second end 130 is provided with the second mounting groove 131. The first mounting bracket 211 is inserted into the first mounting groove 121, with its outer side surface flush with the outer surface of the first end 120. The second mounting bracket 212 is inserted into the second mounting groove 131, with its outer side surface flush with the outer surface of the second end 130. From an appearance perspective, the first mounting bracket 211 and the second mounting bracket 212 appear to be integrally formed with the housing 110. In use, only the at least one massage component 220 come into contact with the user, resulting in a design with enhanced aesthetics and higher surface flatness.

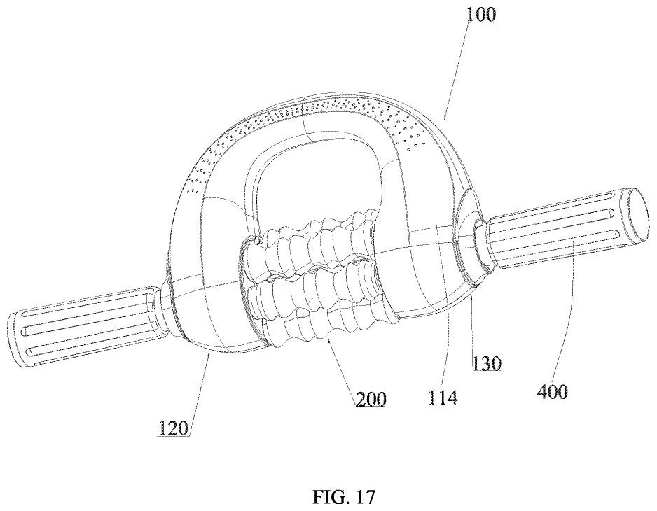

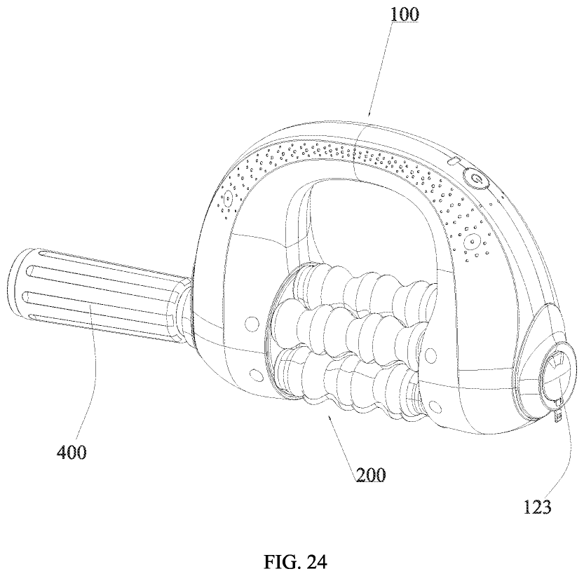

In this embodiment, the massage device further includes a handle 400 detachably connected to at least one of the outer side of the first end 120 and the outer side of the second end 130. With the arrangement of the above structure, as shown in FIGS. 17-23, preferably, the number of the handles 400 is two; at this time, the two handles 400 are respectively connected to the outer side of the first end 120 and the outer side of the second end 130. The two handles 400 on both sides provide the user with additional gripping portions, which facilitate stable holding of the entire massage device during use, especially when massaging the back, waist, and other parts, the massage distance can be extended through the handles 400. It should be noted that, as shown in FIG. 24, when the number of the handles 400 is one, the user can hold the handle 400 with one hand while the other hand assists in pressing the massage assembly 200, or the handle 400 can be used as a supporting point to lean against other parts requiring massage, thereby forming a lever-type massage operation that adapts to the massage habits of different users.

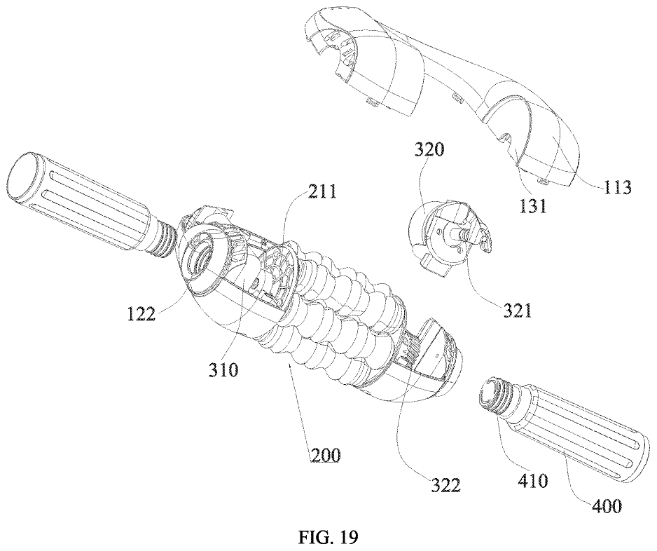

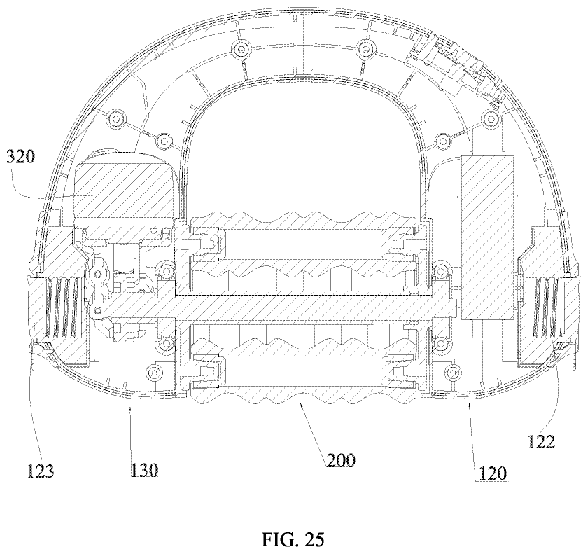

In this embodiment, the outer sides of the first end 120 and the second end 130 are provided with threaded mounting members 122, and the handle 400 is provided with a threaded connecting member 410, wherein the threaded connecting member 410 is detachably connected to the threaded mounting member 122. With the arrangement of the above structure, as shown in FIGS. 19-21, the outer sides of the first end 120 and the second end 130 are provided with threaded mounting members 122, and the handle 400 is correspondingly provided with a threaded connecting member 410, such that a detachable connection between the first end 120/the second end 130 and the handle 400 is achieved through the threaded structure. Preferably, as shown in FIGS. 24 and 25, a sealing member 123 is further included. When the handle 400 is not connected to the outer side of the first end 120 or the second end 130, the threaded mounting member 122 is exposed to the external environment. At this time, connecting the sealing member 123 to the threaded mounting member 122 can effectively block the opening of the threaded mounting member 122, thereby preventing dust or sweat from causing damage to the massage device.

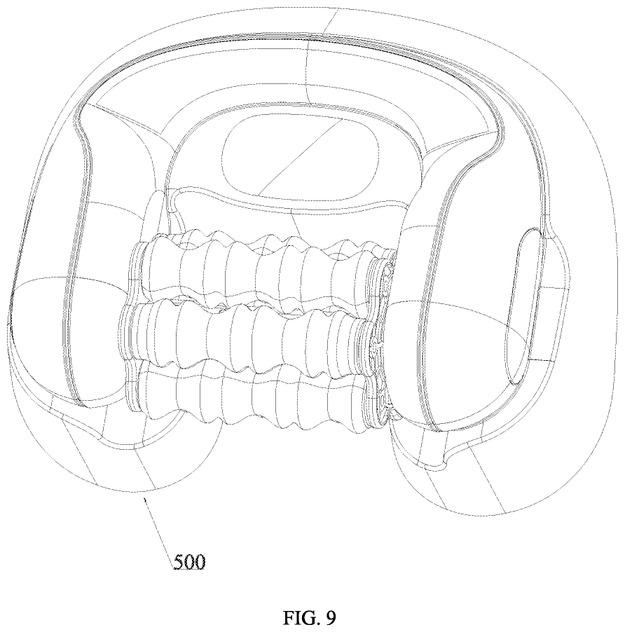

In this embodiment, the massage device further includes a base 500, the housing 110 is placed on the base 500. With the arrangement of the above structure, as shown in FIGS. 9-10, FIGS. 15-16, and FIGS. 22-23, the storage state of the massage device is illustrated, wherein the base 500 provides a stable storage platform for the housing 110. After the massage device is used, the housing 110 can be directly placed on the base 500; in addition, the base 500 can also serve as a supporting platform for display or standby, particularly in commercial places such as beauty salons and physiotherapy shops.

In this embodiment, the massage device further includes a charging port 311 electrically connected to the battery 310. With the arrangement of the charging port 311, as shown in FIGS. 2, 12, and 18, the charging port 311 enables the battery 310 to be charged without disassembly. The user only needs to connect an external power source (such as a USB charger or a power bank) to the massage device through a charging cable, so as to replenish electric energy for the battery 310, thereby avoiding the trouble of frequently replacing batteries or using a dedicated charger. Preferably, the charging port 311 can adopt a universal interface, such as a USB Type-C, Micro-USB, or Lightning interface, thereby enhancing the versatility and compatibility of the massage device.

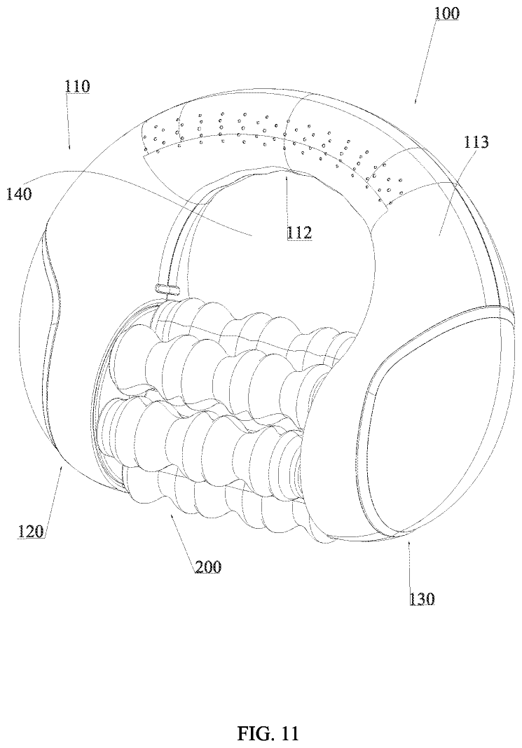

In this embodiment, the housing 110 is provided with a gripping portion 112 configured to allow gripping by a user's hand. With the arrangement of the gripping portion 112, as shown in FIGS. 2 and 11, the gripping portion 112 provides the user with a clear hand gripping area, which conforms to ergonomic design. The gripping portion 112 is located at a position corresponding to the massage assembly 200 and does not affect the user's massage operation. Preferably, the gripping portion 112 is provided with anti-slip textures, is covered with soft rubber material, or has a concave shape conforming to the curve of the human palm, thereby improving comfort and controllability during prolonged use and reducing hand fatigue.

In this embodiment, an opening 140 is defined between the first end 120 and the second end 130 configured to allow a hand to pass through so as to grip the gripping portion 112. With the arrangement of the above structure, as shown in FIGS. 2, 12, and 17, the design of the opening 140 enables the user to pass the palm through the opening 140 and then grip the gripping portion 112, thereby achieving a more secure gripping manner. After the hand passes through the opening 140, the gripping portion 112 is positioned exactly at the center of the palm or the tiger's mouth, such that the center of gravity of the massage device is closer to the hand, facilitating the user to flexibly control the pressing angle and force of the massage assembly 200. This is particularly suitable for prolonged or large-area massage operations and reduces the burden on the user's wrist.

In this embodiment, the housing 110 is of a U-shaped structure. With the arrangement of the above structure, as shown in FIGS. 1-2, FIGS. 11-12, and FIGS. 17-18, the U-shaped structure naturally forms the opening 140 between the first end 120 and the second end 130, such that the massage device as a whole presents an open ring-shaped configuration, allowing the user to pass the hand through the opening 140 and grip the gripping portion 112. The two arms of the U-shaped structure are respectively the first end 120 and the second end 130, providing stable support points for the pivotal connection on both sides of the mounting frame 210.

In this embodiment, the shape of the base 500 matches the shape of the housing 110. With the arrangement of the above structure, as shown in FIGS. 9-10, FIGS. 15-16, and FIGS. 22-23, the base 500 matches the shape of the housing 110, such that surface contact or contoured fitting is formed between the massage device and the base 500. After the massage device is placed, it is not prone to shaking, thereby improving the stability and safety of storage of the massage device. Preferably, the base 500 is respectively provided with slots for accommodating the first end 120, the second end 130, and the gripping portion 112. In addition, the base 500 is further provided with a slot for accommodating the handle 400. It should be noted that the bottom of the base 500 is further provided with an anti-slip structure, such that the base 500 can be stably placed on a supporting surface.

The foregoing describes one or more embodiments provided in connection with specific contents, and it is not intended that the specific implementations of the present disclosure are limited only to these descriptions. Any approximations, similarities, or technical deductions or substitutions made based on the concept of the present disclosure with respect to the method, structure, and the like of the present disclosure shall be deemed to fall within the protection scope of the present disclosure.

What is claimed is:

1. A massage device, comprising:
a gripping assembly having a housing, the housing comprises a first end and a second end disposed opposite each other;
a massage assembly having a mounting frame and at least one massage component, wherein the mounting frame is rotatably connected to the first end and the second end of the housing so as to be rotatable about a first axis, and the at least one massage component being rotatably mounted to the mounting frame so as to be rotatable about a second axis different from the first axis; and
a driving assembly configured to rotate the mounting frame about the first axis.

2. The massage device of claim 1, wherein the mounting frame comprises a first mounting bracket, a second mounting bracket, and a mounting shaft defining the first axis;
wherein opposite ends of the mounting shaft are rotatably connected to the first end and the second end of the housing, respectively;
the first mounting bracket and the second mounting bracket are fixedly connected to the mounting shaft, the first mounting bracket being located closer to the first end and the second mounting bracket being located closer to the second end;
the driving assembly is connected to the mounting shaft and configured to drive the mounting shaft to rotate about the first axis, thereby rotating the first mounting bracket and the second mounting bracket synchronously.

3. The massage device of claim 2, wherein the first mounting bracket comprises a first mounting portion and the second mounting bracket comprises a second mounting portion positioned opposite to the first mounting portion;
wherein opposite ends of each massage component are rotatably connected to the first mounting portion and the second mounting portion, respectively.

4. The massage device of claim 3, wherein both ends of each massage component are provided with a first insertion portion and a second insertion portion, the first insertion portion and the second insertion portion define the second axis;
wherein the first insertion portion is movably inserted into the first mounting portion and the second insertion portion is movably inserted into the second mounting portion such that the massage component is rotatable about the second axis.

5. The massage device of claim 4, wherein each massage component is of a hollow body, and the first insertion portion and the second insertion portion are interference fitted into opposite ends of the hollow body.

6. The massage device of claim 3, wherein the first mounting portion extends from the first mounting bracket toward the second mounting bracket, and the second mounting portion extends from the second mounting bracket toward the first mounting bracket, and wherein at least a portion of the first mounting portion, at least a portion of the second mounting portion, or both, extends into an interior of the massage component.

7. The massage device of claim 2, wherein the housing comprises an upper housing and a lower housing which together define an accommodating space.

8. The massage device of claim 7, wherein the driving assembly comprises a battery and a driving member disposed within the accommodating space, the battery being electrically connected to the driving member to power the driving member.

9. The massage device of claim 8, wherein the driving member is provided with a worm screw, and the driving assembly further comprises a gear engaged with the worm screw, the gear is sleeved around an outer periphery of the mounting shaft; wherein the driving member is configured to drive the worm screw to rotate, thereby driving the gear to rotate synchronously therewith, such that the mounting shaft rotates about the first axis.

10. The massage device of claim 8, wherein the driving assembly further comprises a control button configured to control at least one of power on/off and rotation frequency of the driving member.

11. The massage device of claim 2, wherein the driving assembly further comprises a first bearing mounted at the first end of the housing and a second bearing mounted at the second end of the housing, and wherein opposite ends of the mounting shaft are supported by the first bearing and the second bearing, respectively.

12. The massage device of claim 2, wherein the first end of the housing defines a first mounting groove configured to receive the first mounting bracket, such that an outer surface of the first mounting bracket is substantially flush with an outer surface of the first end; and the second end of the housing defines a second mounting groove configured to receive the second mounting bracket, such that an outer surface of the second mounting bracket is substantially flush with an outer surface of the second end.

13. The massage device of claim 1, further comprising a handle detachably connected to at least one of the first end and the second end of the housing.

14. The massage device of claim 13, wherein the first end and the second end are each provided with a threaded mounting member, and the handle is provided with a threaded connecting member configured to detachably engage to the threaded mounting member.

15. The massage device of claim 1, further comprising a base on which the housing is placed.

16. The massage device of claim 8, further comprising a charging port electrically connected to the battery.

17. The massage device of claim 1, wherein the housing comprises a gripping portion configured to be grasped by a user's hand.

18. The massage device of claim 17, wherein an opening is defined between the first end and the second end of the housing, the opening is configured to allow the user's hand to pass therethrough to grip the gripping portion.

19. The massage device of claim 1, wherein the housing is of a U-shaped structure.

20. The massage device of claim 15, wherein the base is formed in a shape that complementary in shape to the housing.
